(19) United States
(12) Patent Application Publication
(10) Pub. No.: US 2018/0004476 A1
(43) Pub. Date: Jan. 4, 2018

(54) MEDIA PRODUCTION TO OPERATING SYSTEM SUPPORTED DISPLAY

(71) Applicant: Microsoft Technology Licensing, LLC, Redmond, WA (US)

(72) Inventors: Aaron Wesley Cunningham, Redmond, WA (US); Scott Plette, Kirkland, WA (US); Steven Marcel Elza Wilssens, Bothell, WA (US); Vincent Bellet, Kirkland, WA (US); Todd R. Manion, Seattle, WA (US); Luke Angelini, Seattle, WA (US); Chinweizu Owunwanne, Renton, WA (US); Anders Edgar Klemets, Redmond, WA (US)

(21) Appl. No.: 15/199,571

(22) Filed: Jun. 30, 2016

(51) Int. Cl. G06F 3/14; G06F 3/0484

(52) U.S. Cl. CPC G06F 3/1454; G06F 3/0484; G06F 2203/04803

(57) ABSTRACT

The rendering of media generated by media production systems on a display of a different computer system that operates an operating system. A display of a computer system that operates an operating system is sometimes referred to as a smart display. When the computer system receives the media from the media production system(s), the computer system formulates an operating system control that, when triggered, performs one or more operating system operations. The computer system then displays a visualization of the operating system control along with at least part of the received media on the display of the computer system. The operating system control is structured so as to be triggered when a user interacts in at least a particular way with the visualization of the operating system control. Thus, rather than simply render the media as provided, additional operating system level control is provided by the smart display.

### BACKGROUND

Computer systems quite regularly generate, produce, and render media content. Examples of media content include video, audio, pictures, or any other content that can be recognized by the human senses. Computer systems can appropriately render such media on an appropriate output device. For instance, video data, image data, and animations can be readily rendered on a display. Audio can be rendered using speakers. It is common for displays to have integrated speakers so as to render both visual and auditory output (e.g., a movie).

Sometimes, media outputted from one computer system can be rendered on another computer system. For instance, in a duplication embodiment, content displayed on a display of one device is mirrored onto another display. To do so, there may be some resizing performed in order to accommodate a larger or smaller display, but essentially what appears on one display also appears on the other display. In an extended embodiment, media may be dragged and dropped from one display into another. Thus, the second display represents an extension of the first display.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to the rendering of media generated by one more media production systems on a display of a different computer system that operates an operating system. A display of a computer system that runs an operating system will hereinafter also be referred to as a “smart” display. When the computer system receives the media from the media production system(s), the computer system formulates an operating system control that, when triggered, performs one or more operating system operations. The operating system control is structured so as to be triggered when a user interacts in at least a particular way with the visualization of the operating system control.

Thus, rather than simply render the media as provided, additional operating system level control is provided by the smart display. This allows for more capable interaction and control of the media content at the level of operations of the operating system itself. For instance, a user may be able to perform numerous operations to manipulate the boundaries of a visualization of the operating system control/received media, including snapping the visualization to a particular portion of a computer system display, minimizing the visualization to less than full-screen, maximizing the visualization to full-screen, and closing the visualization.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer system in which the principles described herein may be employed;

FIG. 2 illustrates an example environment for projecting media displayed on media production system to a display of a computer system.

FIG. 3 illustrates a method for wirelessly coupling a media production system to a computer system to thereby project content from a display of the media production system onto a display of the computer system.

FIG. 4 illustrates a method for formulating at least one operating system control in response to receiving media from one or more media production systems.

### DETAILED DESCRIPTION

At least some embodiments described herein relate to the rendering of media generated by one more media production systems on a display of a different computer system that operates an operating system. A display of a computer system that runs an operating system will hereinafter also be referred to as a “smart” display. When the computer system receives the media from the media production system(s), the computer system formulates an operating system control that, when triggered, performs one or more operating system operations. The operating system control is structured so as to be triggered when a user interacts in at least a particular way with the visualization of the operating system control.

Thus, rather than simply render the media as provided, additional operating system level control is provided by the smart display. This allows for more capable interaction and control of the media content at the level of operations of the operating system itself. For instance, a user may be able to perform numerous operations to manipulate the boundaries of the visualization of the operating system control/received media, including snapping the visualization to a particular portion of a computer system display, minimizing the visualization to less than full-screen, maximizing the visualization to full-screen, and closing the visualization.

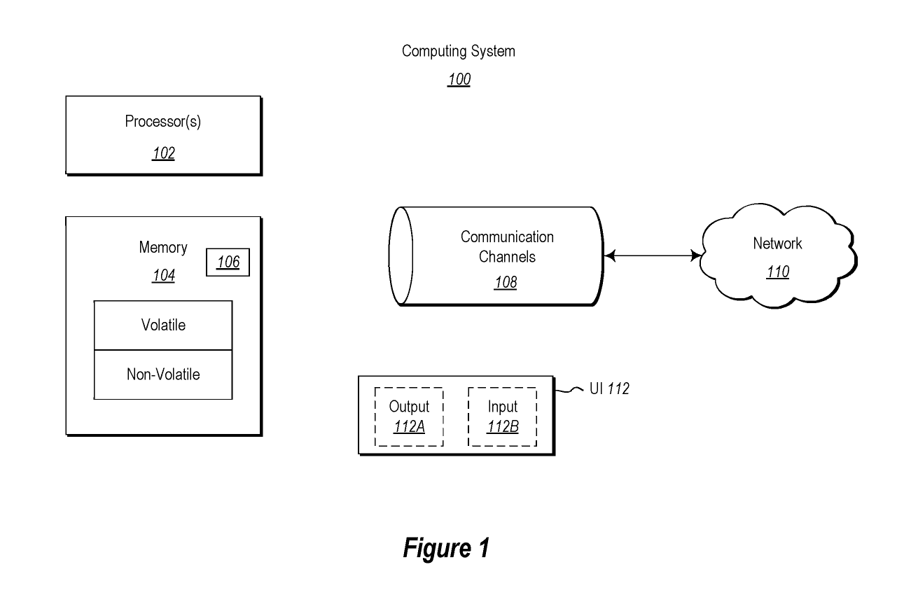

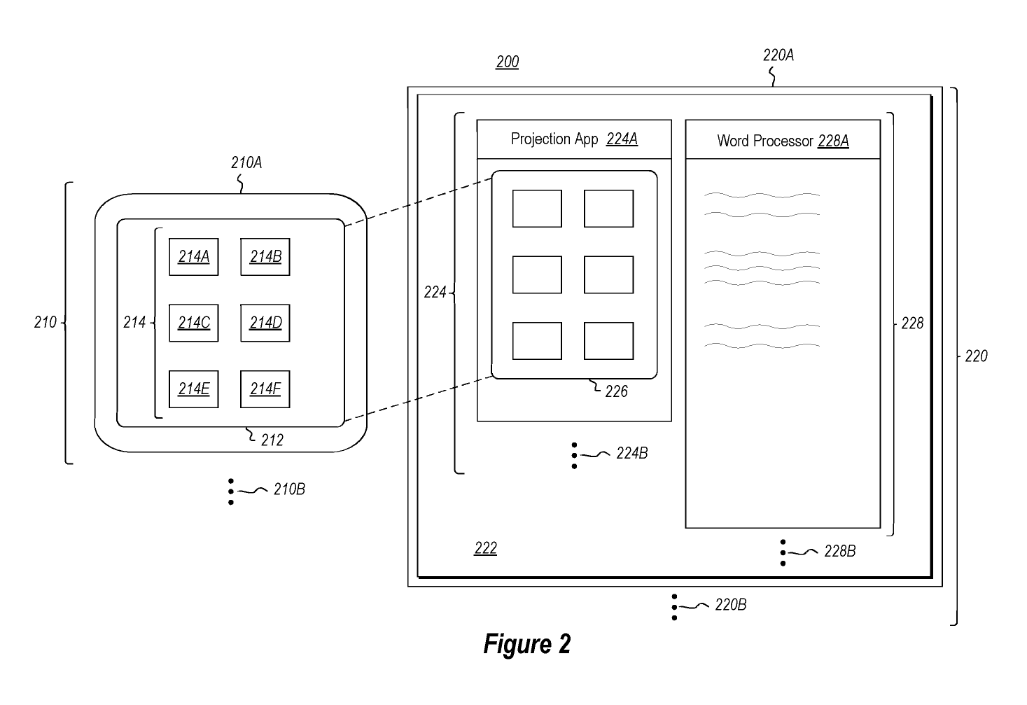

Some introductory discussion of a computing system will be described with respect to FIG. 1. Then, projecting content/media currently displayed on a media production system onto a display of a separate computer system will be described with respect to FIGS. 2 through 4.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “control” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

FIG. 2 illustrates an environment 200 in which the principles described herein may operate. The environment 200 includes media production system 210A having a display 212. While FIG. 2 only shows one media production system 210A, ellipses 210B illustrates that there may be any number of media production systems 210. Media production system 210A may comprise a smartphone, tablet, smartwatch, smart glasses, or any other device having a mobile OS (e.g., ANDROID™ OS) or desktop OS (e.g., WINDOWS® OS). For example, media production system 210A may be a smartphone running WINDOWS OS.

Display 212 may comprise a touchscreen that allows a user to interact with media production system 210A. For example, a user may perform any operation provided by a modern OS/device, including opening apps, playing games, viewing/editing pictures, streaming videos, and so forth. Accordingly, display 212 may act as an input device to media production system 210A. Alternatively, media production system 210A may be coupled to a keyboard and/or a mouse, which devices may be used as input devices to interact with media production system 210A. Such a keyboard and mouse may be coupled to media production system 210A by any appropriate standard (e.g., BLUETOOTH®, USB, micro-USB, USB TYPE-C®, and so forth).

FIG. 2 also includes computer system 220A. While only one computer system 220A is shown, ellipses 220B represent that there may be any number of computer systems 220 on which content (i.e., from a media production system 210) can be projected. Computer system 220A may comprise a smart display, as described herein. As an example, computer system 220A may be a desktop or a laptop PC W running WINDOWS OS. As shown, computer system 220A includes display 222, which display 222 may comprise a touchscreen or non-touch enabled device. Computer system 220A also includes two apps, app 224A and app 228A. While only one app 224A and one app 228A are shown, ellipses 224B and ellipses 228B represent that there may be any number of apps 224 and apps 228 running/being displayed on computer system 220A.

App 224A may comprise a projection app that is capable of projecting/rendering content currently shown on display 212 of media production system 210A (i.e., whatever appears on media production system 210A may also appear on computer system 220A). For example, suppose that display 212 of media production system 210A is currently displaying a home screen that shows apps 214A through 214F (collectively referred to as “apps 214”) that are currently installed on the media production system. As illustrated by projected image 226 within projection app 224A, computer system 220A may use projection app 224A to project/render the content currently being shown (i.e., the home screen displaying apps 214) on display 212, within the display 222 of computer system 220A. Accordingly, any content, including images, videos, apps, animations, and so forth, being displayed on media production system 210A may be projected onto display 222 of computer system 220A via the projection app 224A.

In some embodiments, projected image 226 rendered by projection app 224A may be a static image that cannot be manipulated by a user, outside of manipulating the boundaries of the projection app 224A, as described more fully herein. In other embodiments, the projected image 226 may be manipulated in any number of ways by a user. As an example, a user may be able to drag a file from the projected image 226 and drop it on the screen/display 222 of computer system 220A, thus transferring the file from media production system 210A to computer system 220A. In another example, a user may be able to edit a projected image 226 that comprises a photo (e.g., brightness, contrast, color, and so forth). In yet another example, a user may be able to open, and interact with, one or more of the apps 212 within the projection app 224A/projected image 226. Accordingly, a user may be able to manipulate projected image 226 in any way that the user would be able to do, if the user were interacting directly with the content as displayed on media production system 210A.

In some embodiments, projection app 224A may comprise an application that comes bundled on an OS of computer system 220A (e.g., WINDOWS). In other embodiments, projection app 224A may be downloaded and installed from an app store. As such, projection app 224A may include various controls that allow for manipulation of the app and/or the boundaries of the window/frame in which the app is rendered. For example, projection app 224A may include the ability to snap the window of the rendered projection app 224A to a particular portion of display 222 (i.e., the window may then be rendered on less than an entirety of the computer system display). In a more specific example, projection app 224A may be snapped to the left-hand side or right-hand side of display 222, thus occupying approximately 50% of the display 222. Additionally, projection app 224A may include controls capable of maximizing the app, minimizing the app, recording content being rendered within the app, fast-forward content being rendered within the app, rewind content being rendered within the app, pausing content being rendered within the app, broadcasting content being rendered within the app, and so forth.

Furthermore, as described briefly and illustrated by ellipses 224B, there may be any number of projection apps being displayed within display 222, wherein each projection app corresponds to a different media production system 210. As such, each projection app may be associated with a particular media production system 210, and thus be capable of displaying a projection of the content currently being displayed on the particular media production system with which each projection app is associated. Additionally, as briefly described and illustrated, while only one app 228A is shown, ellipses 228B represents that any number of apps 228 may also be running/displayed on computer system 220A and display 222. Thus, computer system 220A is capable of rendering one or more projection apps 224, while at the same time rendering one or more other apps 228. As such, a user of computer system 220A may use projection app 224A to project/render content displayed on media production system 210A, while utilizing various other apps (e.g., a word processing app) at the same time

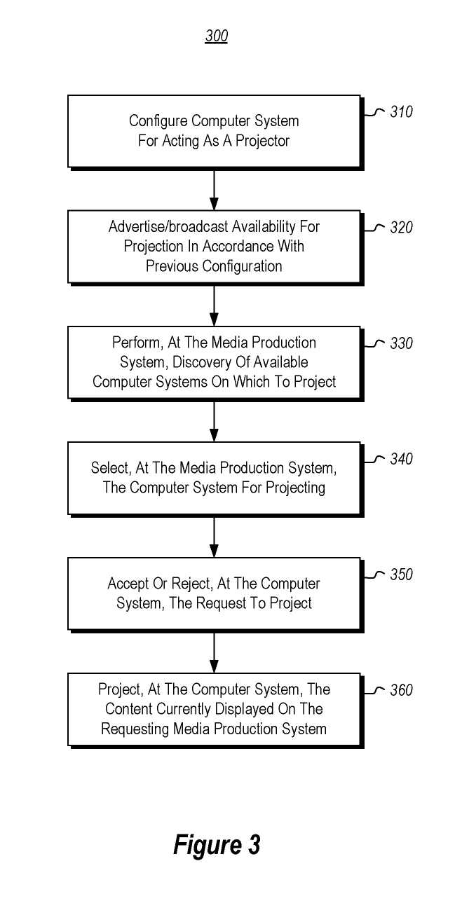

FIG. 3 refers frequently to the environment/components of FIG. 2 and illustrates a method 300 for wirelessly coupling media production system 210A and computer system 220A such that content displayed on the media production system 210A (i.e., on display 212) may be projected/rendered on computer system 220A (i.e., display 222). The method 300 may begin when the computer system 220A has been registered/configured for acting as a projector (Act 310). As an example, suppose a user has a desktop PC running WINDOWS OS. The user (or a business/enterprise in some embodiments) may be able to set up policies regarding how the desktop PC is to act with respect to projecting content displayed on a media production system 210.

More specifically, a user may be able to configure when the desktop PC is to advertise/broadcast itself as a potential projector for a media production system (e.g., a smartphone, a tablet, and so forth). In other words, when a computer system 220 is discoverable by a media production system 210 may be user-configurable. In some embodiments, a computer system 220 may always be discoverable, assuming the computer system is currently on. Alternatively, a computer system 220 may always be discoverable as long as the computer system is both on and unlocked. In other embodiments, advertising/broadcasting may only occur upon a user opening projection app 224A. In such embodiments, a user may be able make a computer system 220 not discoverable by closing projection app 224A.

Power management may also be considered with respect to when a computer system 220 is to advertise/broadcast the computer system's availability. For instance, a computer system 220 may always broadcast unless a battery life percentage has dropped below a certain threshold (e.g., 15% or less of battery life remaining). Additionally, the network to which a computer system 220 is connected may also be considered with respect to advertising/broadcasting projection availability. As an example, a user may be able to categorize certain networks as being free or trusted. As such, the computer system may always broadcast when connected to those networks. Additionally, when connected to a public network or a metered connection (i.e., the user pays per unit of time or per unit of data), the computer system may not broadcast unless the user manually selects an option to broadcast the computer system's availability to project.

Furthermore, a user may be able to change the default way in which a computer system 220 reacts to a projection request (the actual requests to project are discussed further herein). As an example, upon receiving a projection request from a media production system 210, projection app 224A may be automatically opened and begin projecting after a certain threshold in time has passed (e.g., between five and thirty seconds) without a user manually opening the app. Alternatively, the default may comprise rejecting a request to project after a certain threshold of time has lapsed since receiving the request without a user opening projection app 224A.

In some embodiments, a PIN/password at the desktop PC may be utilized as a default to stop unwanted projections. In other words, a user of a media production system 210 may have to enter a PIN/password before a computer system 220 allows the media production system to send content to be projected on the computer system. Accordingly, the particular PIN/password used may be determined by a user/owner of a computer system 220. A user may also be able to turn off PIN/password protection, which will automatically grant all incoming projection requests. Additionally, a user may be able to configure a computer system 220 such that any PIN/password protection is automatically turned off in particular situations. As an example, PIN/password protection may automatically turn off when a requesting media production system 210 is currently connected to the same private network as the computer system receiving the projection request. In another example, PIN/password protection may automatically turn off when users of both the media production system and the computer system have the same credentials (i.e., the same person logged-in under the same account on both devices). In a more specific example, PIN/password protection may automatically turn off when the same user is logged-in under the same MICROSOFT® account on both a desktop PC running WINDOWS OS (i.e., a computer system 220) and a WINDOWS phone (i.e., a media production system 210).

During configuration/registration a user may also be able to manually determine the name of a computer system 220 that will be advertised/broadcasted to media productions systems. Similarly, a user may be able to determine the name of a media production system 210 that will be requesting to project content on a computer system 220. As such, a user may be able to change the default name of either type of device in order to more readily determine which computer system 220 will be projecting media and/or which media production system 210 is requesting to project.

In some embodiments, a computer system 220 may have default settings that allow a user to project from a media production system 210 to the computer system, despite the user not having registered/configured the computer system. For instance, a default setting may comprise always advertising/broadcasting that a particular computer system 220 is available for projection when the computer system is both on and unlocked. In other embodiments, a computer system 220 may not advertise/broadcast its availability for projection until being registered/configured.

Once a computer system 220 (i.e., desktop PC or laptop PC running WINDOWS) has been registered/configured (or not, in situations where registration/configuration is not necessary), the computer system may advertise/broadcast its availability for projection in accordance with its previous configuration (Act 320). Advertising/broadcasting may be done under any applicable standard. In some embodiments, a computer system 220 will broadcast itself through Wi-Fi Direct and/or MIRACAST standards. In such instances, media production systems desiring to project to an available PC may have to be MIRACAST-enabled.

While a computer system 220 is advertising/broadcasting its availability, a media production system 210 may be attempting to discover available computer systems on which to project (Act 330). In some embodiments, this discovery may occur before advertising/broadcasting and further may be a catalyst for prompting a computer system 220 to start broadcasting the computer system's availability. In other embodiments, discovery may be happening at the same time as advertising/broadcasting. In such instances, media production system 210A may also be configured/registered to determine how and when to perform discovery of available computer systems on which to project. Accordingly, a user of media production system 210A may be able to configure the media production system in the same or similar ways as those described with respect to the configuration of a computer system 220 herein. For example, a user may be able to configure when a media production system is to attempt discovery, as described herein (e.g., powered on, powered on and unlocked, only in response to an advertisement/broadcast, manually upon user request, and so forth). Furthermore, a user of a media production system 210 may be able to manually change the name of the media production system such that the media production system is more easily identifiable by a user of a computer system 220. In yet other embodiments, discovery may occur in response to receiving an advertisement/broadcast from a computer system 220.

Once media production system 210A has discovered the availability for projection of a computer system 220, the computer system 220 may be selected for projecting (Act 340). In some instances, there may be only one available computer system 220A. Alternatively, there may be many available computer systems 220 from which to choose to broadcast. Selection of an available computer system 220 may then result in a request to project, which request is received at the selected computer system 220. A user of selected computer system 220 may then be able to accept or reject the request to project (Act 350). As such, a user may manually accept or reject any projection request that is received at a computer system 220 (e.g., through the use of a PIN/password, an “Accept” or “Reject” control, and so forth).

As part of the registration/configuration process described herein, a user of a computer system 220 may be able to whitelist/blacklist any media production system 210. Likewise, a user of a media production system 210 may be able to whitelist/blacklist any computer system 220. In such instances, acceptance of a request to project an image sent from a whitelisted media production system may be performed automatically, while blacklisted media production systems may be rejected automatically. In other embodiments, any computer system 220 may be configured such that a PIN/password is always required, even if a requesting media production system 210 has been whitelisted. Regardless, a user may receive information regarding the media production system that is currently requesting to have content projected on a computer system 220. For example, information may include make/model of the media production system, the network to which the media production system is currently connected, whether the media production system has been whitelisted/blacklisted, and so forth.

Upon acceptance, the selected computer system 220 may allow the media production system 210 to send content/media currently being displayed on the media production system to the computer system through any appropriate protocol (e.g., Wi-Fi Direct, MIRACAST). Once the content/media has been received, projection app 224A may begin to project content currently displayed on the requesting media production system 210 (Act 360). In some embodiments, upon acceptance, a computer system 220 may send information (i.e., computer system specifications) regarding the computer system 220 to media production system 210 to thereby enable the media production system to send the most appropriate sized/resolution content/media.

For example, a computer system 220 may inform media production system 210 of the resolution of the computer system's display, screen size of the computer system's display, the OS of the computer system, the processing capabilities of the computer system, and so forth. Furthermore, in cases when the window in which projection app 224A is rendered is less than the entirety of the computer system's display, the computer system may inform the media production system of such. Accordingly, the media production system may be informed of a computer system's resolution/screen size and/or window size of the projection app 224A in order to allow media production system 210 to provide the most suitable size/resolution of the media that the media production system would like projected on the computer system. Additionally, computing resources of either (or both) of the computer system and the media production system may be used in the projection of media from the media production system onto the display of the computer system (e.g., for scaling images).

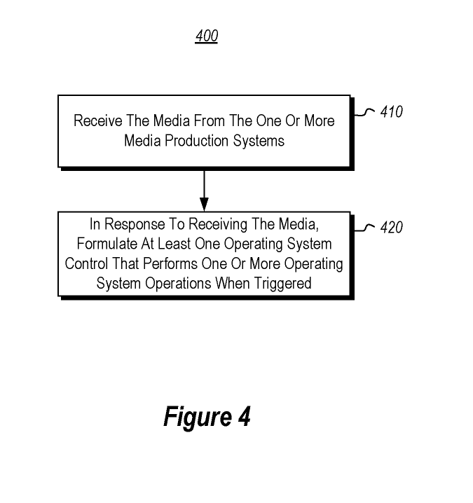

FIG. 4 illustrates a method 400 for formulating at least one operating system control in response to receiving media from one or more media production systems. The method begins when a computer system 210 receives media from one or more media production systems (Act 410). For example, a computer system 220 may have received a photo to project within projection app 224A from a media production system 210. As such, a computer system 220 may have already broadcasted/advertised the computer system's projection availability, received a request from the media production system to have the computer system broadcast content/media, and accepted the request to project.

In response to receiving the media, at least one operating system control may be formulated that performs one or more operating system operations when triggered (Act 420). As an example, computer system 220A may open projection app 224A. Furthermore, the operating system control may be structured so as to be triggered when a user interacts in at least a particular way with the visualization of the operating system control. For instance, projection app 224A may include various controls that allow for manipulating the boundaries of the projection app (e.g., snapping control, minimizing control, maximizing control, and so forth), manipulating the content of the media (e.g., recording control, rewinding control, drag-and-drop control for components included within the media to be projected, and so forth), and configuring how the computer system and OS are to act with respect to projecting media from media production systems (when to broadcast, when to use a PIN/password, and so forth).

After the at least one operating system control is formulated, computer system 220A may cause a visualization of the operating system control to be rendered with at least part of the received media on a display of the computer system. In the continuing example, computer system 220A may render the photo received from computer production system 210A within projection app 224A. Additionally, various controls to provide additional functionality/operations may be included, as described herein (e.g., snapping tools, recording tools, and so forth).

In this way, media shown on a media production system (e.g., a smartphone, a tablet, and so forth) may be projected on a smart display (i.e., a computer system running an OS). Furthermore, one or more OS controls may also be provided to manipulate the projected media, including controls that allow for manipulation of the borders of the projection, as well as manipulation of the projected content itself. As such, the smart display may also provide for interacting with other apps and OS capabilities while media is being projected from a media production system.

The present invention may be embodied in other forms, without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system comprising:
one or more processors;
one or more computer-readable storage media having stored thereon computer-executable instructions that are executable by the one or more processors to cause the computer system to formulate at least one operating system control in response to receiving media from one or more media production systems, the computer-executable instructions including instructions that are executable to cause the computer system to perform at least the following:
receive the media from the one or more media production systems; and
in response to receiving the media, formulate at least one operating system control that performs one or more operating system operations when triggered, the operating system control being structured so as to be triggered when a user interacts in at least a particular way with the operating system control.

2. The computer system of claim 1, wherein the computer system comprises at least one of a laptop and a desktop.

3. The computer system of claim 1, wherein at least one of the one or more media production systems comprises at least one of a smartphone and a tablet.

4. The computer system of claim 1, wherein one or more input devices are coupled to at least one of the one or more media production systems.

5. The computer system of claim 4, wherein at least one of the one or more input devices comprises at least one of a keyboard and a mouse.

6. The computer system of claim 1, wherein the computer system provides the user with an option to decline receiving media from the one or more media production systems.

7. The computer system of claim 1, wherein a visualization of the operating system control is rendered with at least part of the received media on a display of the computer system.

8. The computer system of claim 7, wherein the at least one of the one or more operating system operations comprises snapping the visualization of the operating system control to a particular portion of the display of the computer system.

9. A method, implemented at a computer system that includes one or more processors, for formulating at least one operating system control in response to receiving media from one or more media production systems, comprising:
receiving the media from the one or more media production systems; and
in response to receiving the media, formulating at least one operating system control that performs one or more operating system operations when triggered, the operating system control being structured so as to be triggered when a user interacts in at least a particular way with the operating system control.

10. The method of claim 9, wherein the computer system comprises at least one of a laptop and a desktop.

11. The method of claim 9, wherein at least one of the one or more media production systems comprises at least one of a smartphone and a tablet.

12. The method of claim 9, wherein one or more input devices are coupled to at least one of the one or more media production systems.

13. The method of claim 12, wherein at least one of the one or more input devices comprises at least one of a keyboard and a mouse.

14. The method of claim 9, wherein the computer system provides the user with an option to decline receiving media from the one or more media production systems.

15. The method of claim 9, further comprising causing a visualization of the operating system control to be rendered with at least part of the received media on a display of the computer system.

16. The method of claim 15, wherein the at least one of the one or more operating system operations comprises recording the received media being rendered on the display of the computer system.

17. The method of claim 15, wherein the operating system control is rendered on less than an entirety of the computer system display

18. A computer program product comprising one or more hardware storage devices having stored thereon computer-executable instructions that are executable by one or more processors of a computer system to formulate at least one operating system control in response to receiving media from one or more media production systems, the computer-executable instructions including instructions that are executable to cause the computer system to perform at least the following:
receive the media from the one or more media production systems; and
in response to receiving the media, formulate at least one operating system control that performs one or more operating system operations when triggered, the operating system control being structured so as to be triggered when a user interacts in at least a particular way with the operating system control.

19. The computer program product of claim 18, wherein a visualization of the operating system control is rendered with at least part of the received media on a display of the computer system.

20. The computer program product of claim 18, wherein the computer system provides the user with an option to decline receiving media from the one or more media production systems.
